(19) United States
(12) Patent Application Publication
(10) Pub. No.: US 2008/0150765 A1
(43) Pub. Date: Jun. 26, 2008

(54) METHOD, APPARATUS, AND COMPUTER PRODUCT FOR ASSISTING DRIVING TRAINING

(75) Inventor: Yoshiki NAKAJIMA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/862,541

(22) Filed: Sep. 27, 2007

(30) Foreign Application Priority Data
Dec. 25, 2006 (JP) 2006-348342

(51) Int. Cl. G08G 1/123

(52) U.S. Cl. 340/988

(57) ABSTRACT

A first storing unit stores therein a driving definition defined by tag data of radio IC tags installed in a driving area of a vehicle, which indicates at least one of an adequate driving condition and an inadequate driving condition for the vehicle. An acquiring unit acquires tag data read by a radio IC tag reading device provided in the vehicle from the radio IC tags with a driving of the vehicle. A second storing unit stores acquired tag data in a predetermined storage unit. A judging unit judges an adequacy of a driving condition of the vehicle by comparing stored tag data with stored driving definition.

### BACKGROUND OF THE INVENTION

1. Field of the Invention

The present invention relates to a method, an apparatus, and a computer product for assisting driving training.

2. Description of the Related Art

Various ideas have been proposed in the past with a view to efficiently impart driving skills. Particularly, various methods have been proposed for efficiently imparting driving skills to a trainee who is not adept (i.e., whose driving skills need to be improved).

For example, a dummy driving device is in Japanese Patent Application Laid-open No. H10-111648 for efficiently imparting driving skills, wherein reproduction of mock driving conditions that can potentially result in the vehicle bumping into a pedestrian or another vehicle (that is, driving conditions that require one to be cautious) is repeatedly carried out within the driving school at any time or place the instructor deems necessary.

Specifically, to increase awareness towards the other vehicles and people on either side of the vehicle one is driving (and therefore to avoid driving into a pedestrian or another vehicle), the dummy driving device (a dummy vehicle) is made to run on a driving track by remote operation by the instructor and is made to do an action to indicate danger or to assume a posture indicating danger (for example, fall towards the road, again by remote operation by the instructor).

However, in the technology mentioned above, the instructor's judgment of whether the vehicle is driving on a legitimate track is a subjective one, the judgment being prone to variation even by the same instructor, and even more so if another instructor comes into the picture.

### SUMMARY OF THE INVENTION

It is an object of the present invention to at least partially solve the problems in the conventional technology.

A computer-readable recording medium according to one aspect of the present invention stores therein a computer program for assisting a training of driving a vehicle. The computer program causes a computer to execute first storing including storing a driving definition that is defined using tag data of a plurality of radio integrated-circuit tags installed in a driving area of the vehicle, the driving definition indicating at least one of an adequate driving condition and an inadequate driving condition for the vehicle; acquiring tag data read by a radio integrated-circuit tag reading device provided in the vehicle from the radio integrated-circuit tags with a driving of the vehicle; second storing including storing the tag data acquired at the acquiring in a predetermined storage unit; and judging an adequacy of a driving condition of the vehicle by comparing the tag data stored at the second storing with the driving definition stored at the first storing.

A method of assisting a training of driving a vehicle, according to another aspect of the present invention, includes first storing including storing a driving definition that is defined using tag data of a plurality of radio integrated-circuit tags installed in a driving area of the vehicle, the driving definition indicating at least one of an adequate driving condition and an inadequate driving condition for the vehicle; acquiring tag data read by a radio integrated-circuit tag reading device provided in the vehicle from the radio integrated-circuit tags with a driving of the vehicle; second storing including storing the tag data acquired at the acquiring in a predetermined storage unit; and judging an adequacy of a driving condition of the vehicle by comparing the tag data stored at the second storing with the driving definition stored at the first storing.

An apparatus for assisting a training of driving a vehicle, according to still another aspect of the present invention, includes a first storing unit that stores therein a driving definition that is defined using tag data of a plurality of radio integrated-circuit tags installed in a driving area of the vehicle, the driving definition indicating at least one of an adequate driving condition and an inadequate driving condition for the vehicle; an acquiring unit that acquires tag data read by a radio integrated-circuit tag reading device provided in the vehicle from the radio integrated-circuit tags with a driving of the vehicle; a second storing unit that stores the tag data acquired by the acquiring unit in a predetermined storage unit; and a judging unit that judges an adequacy of a driving condition of the vehicle by comparing the tag data stored in the second storing unit with the driving definition stored in the predetermined storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1C are schematics for explaining an overview and salient feature of a driving training assisting device according to a first embodiment of the present invention;

FIG. 2 is a block diagram of the driving training assisting device according to the first embodiment;

FIG. 3 is a drawing of storage contents of a tag-data storage unit according to the first embodiment;

FIGS. 4A and 4B are drawings of storage contents of a tag-history storage unit according to the first embodiment;

FIGS. 5A and 5B are drawings of driving definitions held by a driving-definition holding unit according to the first embodiment;

FIG. 6 is a flowchart of a track-legitimacy judgment process according to the first embodiment;

FIG. 7 is a flowchart of a driving-data output process according to the first embodiment;

FIG. 8 is a schematic for explaining an overview and salient feature of the driving training assisting device according to a second embodiment;

FIG. 9 is a drawing of storage contents of a driving-definition holding unit according to the second embodiment;

FIG. 10 is a schematic for explaining an overview and salient feature of the driving training assisting device according to a third embodiment;

FIGS. 11A to 11C are schematics for explaining a legitimate-speed judgment process according to the third embodiment;

FIGS. 12A and 12B are schematics for explaining an overview and salient feature of the driving training assisting device that judges legitimacy of the driving condition based on a distance between vehicles;

FIGS. 13A to 13C are schematics for explaining an overview and salient feature of the driving training assisting device that sets driving definition based on a plurality of tag data; and

FIG. 14 is a schematic drawing of computer programs that cause a computer to function as a driving training assisting device according to the first embodiment.

### DETAILED DESCRIPTION OF THE PREFERRED EMBODIMENTS

Exemplary embodiments of the present invention are described in detail below with reference to the accompanying drawings.

The term “Radio integrated circuit (IC) tag” refers to a micro-sized radio IC chip used for identifying an object, and has recorded therein an identification code, etc. A radio IC tag exchanges data with a tag-data retrieving device, described later, by electromagnetic waves, and can be in the form of a label, card, coin, or a stick. The communication distance of a radio IC tag can range from a few millimeters to a few meters. There are two types of radio IC tag, namely, active (one that has a battery incorporated into it and generates weak electromagnetic waves) and passive (without a battery). Either type can be used in the present invention.

The term “tag-data retrieving device” (referred to as tag data retrieval in the claims) refers to a device that exchanges data with the radio IC chip and reads the identification code stored in the radio IC chip. A reader/writer (R/W) generally corresponds to the tag-data retrieving device.

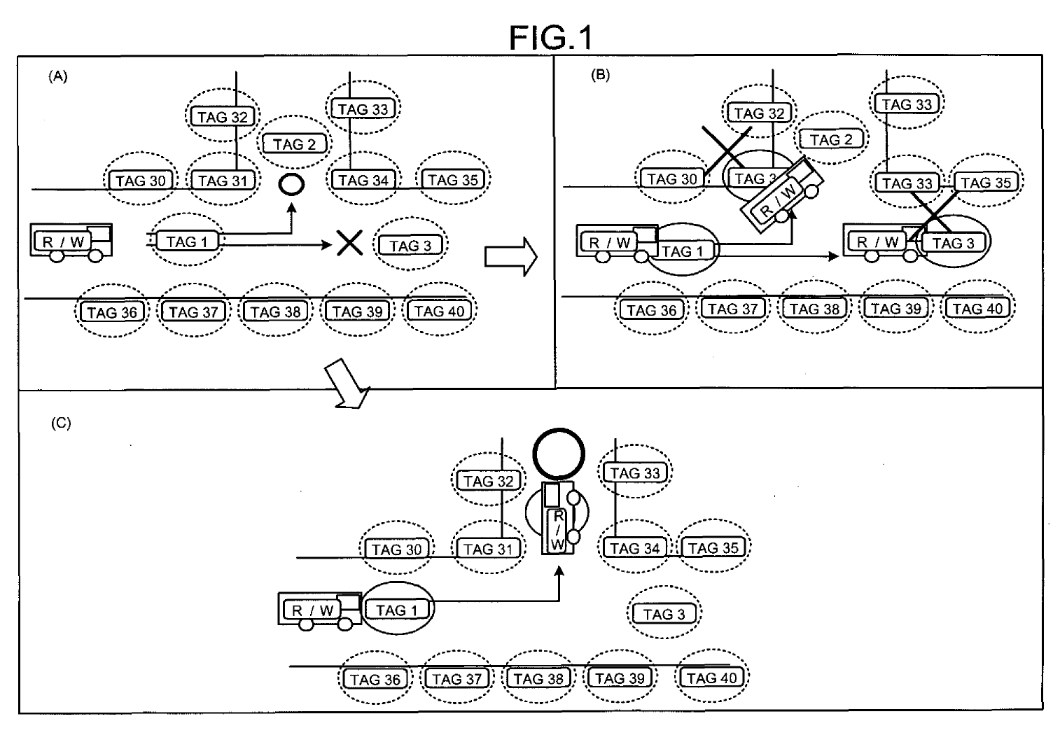

The overview and salient feature of the driving training assisting device according to a first embodiment of the present invention are described below. FIGS. 1A to 1C are schematics for explaining the overview and salient feature of the driving training assisting device according to the first embodiment.

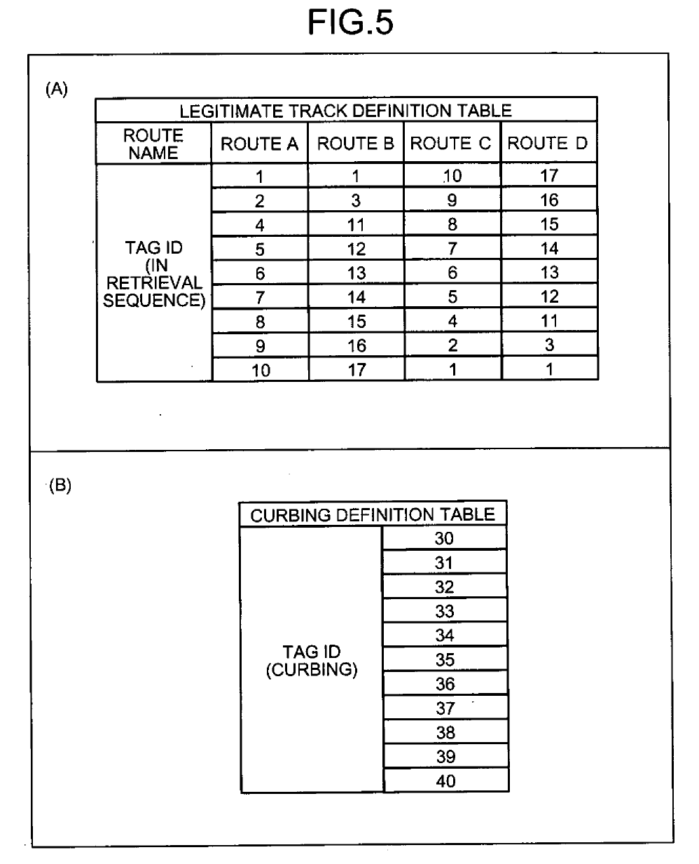

The driving training assisting device according to the first embodiment assists in driving training and, as described below, objectively judges a driving condition of a vehicle. In other words, as shown in FIGS. 1A to 1C, a plurality of radio IC tags, each having tag data recorded thereon, is placed at various spots along the driving track. A radio IC tag reading device is installed within the vehicle, which reads the tag data of a detected radio IC tag. The driving training assisting device according to the first embodiment also has driving definitions that indicate whether the vehicle is driving on a legitimate track. Each driving definition is a series of the radio IC tags. Specifically, driving definitions that the driving training assisting device has are series of tag data of the radio IC tags placed along the legitimate tracks on which the vehicle should be driving and at the barred spots where the vehicle should not be driving (for example, in the event of the vehicle driving off the track, or driving into the curb, etc.) (see FIGS. 5A and 52).

The driving training assisting device according to the first embodiment retrieves the tag data read from the radio IC tags that fall in the path of the vehicle by the radio IC tag reading device installed in the vehicle, and stores the tag data in a predetermined storage unit. For example, in the example shown in FIG. 1C, the driving training assisting device retrieves as tag data “Tag 1” and “Tag 2” according to the radio IC tags that fall in the path of the vehicle.

The driving training assisting device then compares the tag data stored in the storage unit with the driving definitions to judge whether the vehicle is driving on a legitimate track (see FIG. 1A). For example, the driving training assisting device judges whether the retrieved tag data is identical to any driving definition that indicates a legitimate track (that is, whether the sequence of the tag data is legitimate), and if so, judges that the vehicle is driving on a legitimate track (see FIG. 1C). Otherwise, that is, if the retrieved tag data is not identical to any of the driving definitions that indicate the legitimate tracks, the driving training assisting device judges that the vehicle is not driving on a legitimate track (see FIG. 1B). The driving training assisting device further compares the retrieved tag data and the driving definition that indicates barred spots (for example, tags that would indicate the vehicle to be driving off the track or driving into the curb, etc.), and if they match, judges that the vehicle has run off the track or has run into the curb (see FIG. 1B). Otherwise, the driving training assisting device judges that the vehicle has not run off the track nor run into the curb (see FIG. 1C).

Thus, the driving training assisting device according to the first embodiment is able to objectively assess whether the vehicle is driving on a legitimate track, uninfluenced by the evaluator's own opinion or capability.

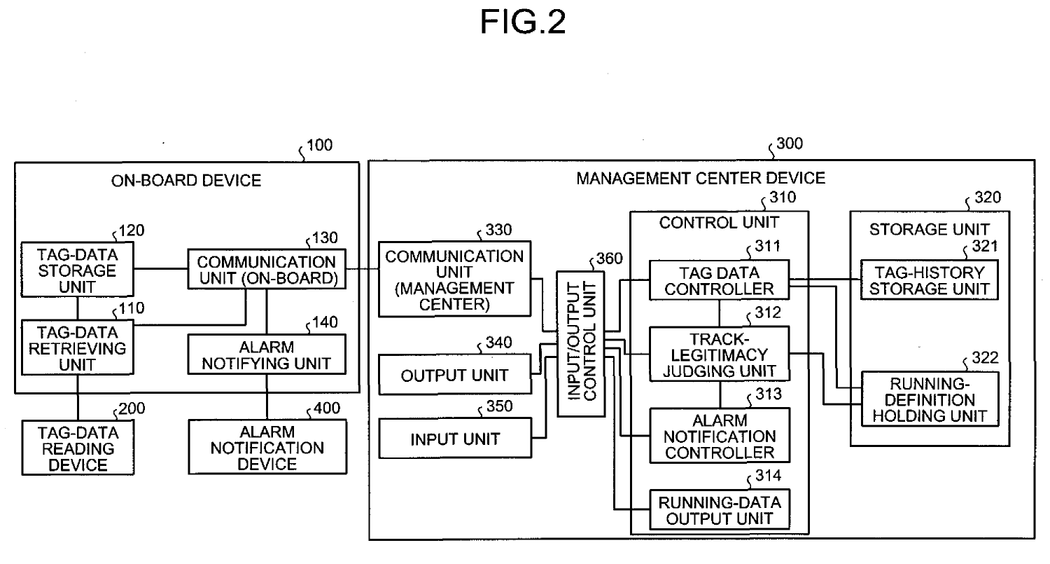

The configuration of the driving training assisting device shown in FIGS. 1A to 1C is described below. FIG. 2 is a block diagram of the driving training assisting device according to the first embodiment. The driving training assisting device includes an on-board device 100, a tag-data reading device 200, an alarm notification device 400, and a management center device 300. The on-board device 100 and the management center device 300 correspond to the driving training assisting device according to the present invention.

The tag-data reading device 200 is installed in the vehicle and reads the tag data from the radio IC tags that fall in the path of the vehicle. Specifically, upon detection of a radio IC tag, the tag-data reading device 200 retrieves the tag data (for example, the tag ID) of the radio IC tag.

The alarm notification device 400 is also installed in the vehicle and sets off an alarm upon receiving an alarm notification from an alarm notifying unit 140 described later. The alarm notification device 400, for instance, sets off a buzzer or triggers a warning upon receiving an alarm notification.

The on-board device 100 performs processes related to tag data retrieval and alarm notification. In close relevance to the present invention, the on-board device 100 includes a tag-data retrieving unit 110, a tag-data storage unit 120, a communication unit (on-board) 130, the alarm notifying unit 140. The tag-data retrieving unit 110 is referred to as tag data storage in the claims.

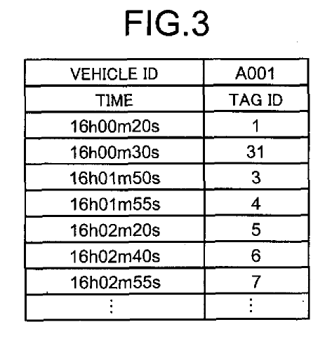

The tag-data storage unit 120 stores therein the tag data retrieved by the tag-data retrieving unit 110 described later and is made of memory. Specifically, as shown in FIG. 3, the tag-data storage unit 120 stores therein vehicle ID that indicates a unique identification number of the vehicle, tag ID that indicates the retrieved tag data, and time that indicates the time when the tag data is retrieved. When a stored tag ID (tag data) is read from the tag-data storage unit 120 and passed on to the management center device 300 the tag ID (tag data) is deleted and a new tag ID (tag data) takes its place.

FIG. 3 is a drawing of storage contents of the tag-data storage unit according to the first embodiment. As an example from FIG. 3, the tag-data storage unit 120 stores therein “A001” as the vehicle ID, and “16h:00m:20s” as the time and “1” the tag ID. The time and the tag ID are stored in an associated form.

The tag-data retrieving unit 110 retrieves the tag data read from the radio IC tags that fall in the path of the vehicle. Specifically, when the tag-data retrieving unit 110 detects a radio IC tag, the tag-data reading device 200 retrieves the tag data (that is, “1” as the tag ID that uniquely identities the detected radio IC tag) of the detected radio IC tag and associates the tag data with the time (for example, “16h:00m:12s”) at which the tag data is retrieved, and stores the tag data in an associated form with the time in the tag-data storage unit 120. The tag data in an associated form with the time stored in the tag-data storage unit 120 is passed along to the management center device 300 through the communication unit (on-board) 130. The tag-data retrieving unit 110 is referred to as tag data retrieval in the claims.

The communication unit (on-board) 130 performs processes related to sending and receiving data. For example, the communication unit (on-board) 130 sends tag data to the management center device 300 and receives alarm notification from the management center device 300.

The alarm notifying unit 140 receives the alarm notification from the management center device 300 and passes along the alarm notification to the alarm notification device 400.

The management center device 300 performs the processes related to tag data retrieval and alarm notification. In close relevance to the present invention, the management center device 300 includes a control unit 310, a storage unit 320, a communication unit (management center) 330, an output unit 340, an input unit 350, and an input/output (I/O) control unit 360.

The communication unit (management center) 330 performs processes related to sending and receiving data. For example, the communication unit (management center) 330 receives the tag data from the management center device 300 and sends the alarm notification to the management center device 300.

The output unit 340 outputs various types of data and includes a monitor (or a display, touch panel, etc.) and a speaker. The output unit 340, for example, outputs tag data (driving-related data) stored in a tag-history storage unit 321 described later.

The input unit 350 accepts various types of data and includes a keyboard, a mouse, a mike etc. The input unit 350, for example, accepts an alarm definition to be stored in a driving-definition holding unit 322 described later, or a command to output tag data (driving-related data) stored in the tag-history storage unit 321.

The I/O control unit 360 controls communication pertaining to various types of data that is sent to and sent from the management center device 300.

The storage unit 320 stores therein data and computer programs necessary for various processes performed by the control unit 310. In close relevance to the present invention, the storage unit 320 includes the tag-history storage unit 321 and the driving-definition holding unit 322. The tag-history storage unit 321 is referred to as tag data storage and the driving-definition holding unit 322 is referred to as driving definition holding in the claims.

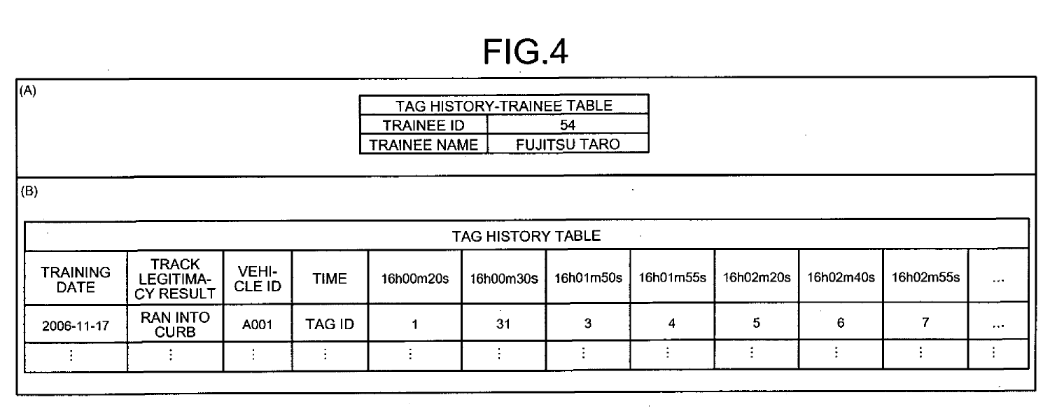

The tag-history storage unit 321 stores therein the tag data retrieved by the tag-data retrieving unit 110. FIGS. 4A and 4B are drawings of storage contents of the tag-history storage unit according to the first embodiment. As shown in FIGS. 4A and 4B, the tag-history storage unit 321 includes two tables, namely a tag history-trainee table and a tag history table. The tag-history storage unit 321 stores the columns trainee ID that uniquely identifies the trainee and trainee name that indicates the trainee's name, in an associated form, in the tag history-trainee table. In the tag history table, the tag-history storage unit 321 stores the columns training date indicating the date of training, a track legitimacy result judged by a track-legitimacy judging unit 312 described later, indicating a judgment of whether vehicle is on a legitimate track, vehicle ID, time, in an associated form.

In the example shown in FIGS. 4A and 4B, in the tag history-trainee table of the tag-history storage unit 321, “54” as trainee ID, “Fujitsu Taro” as trainee's name are stored in an associated form. In the tag history table of the tag-history storage unit 321, “2006-11-17” is stored as training date”, “Ran into curb” is stored as the track legitimacy result, and “A001” is stored as vehicle ID, and “16h:00m:20s” and “I” are stored in an associated form as time and tag ID, respectively.

The driving-definition holding unit 322 holds driving definitions that are defined by tag data of the plurality of radio IC tags placed along the driving track of the vehicle that indicate legitimate tracks and barred spots. Specifically, the driving-definition holding unit 322 holds driving definitions containing series of tag data of the radio IC tags placed in the legitimate track on which the vehicle should be driving and driving definitions containing series of tag data of the radio IC tags placed at spots (barred spots) where the vehicle should not be driving.

More specifically, the driving-definition holding unit 322 holds driving definitions in the form of a legitimate track definition table, as shown in FIG. 5A and a curbing definition table, as shown in FIG. 5B. The legitimate track definition table contains the columns route name indicating the legitimate track and tag ID (in retrieval sequence) indicating the tag data of the radio IC tags placed in the legitimate track in an associated form. The curbing definition table contains the column tag ID (curbing) indicating the tag data of all the radio IC tags that are placed at barred spots such as along the curb.

In the example shown in FIG. 5A, the driving-definition holding unit 322 stores the route name “Route A” associated with the tag IDs (in retrieval sequence) “1,2,4,5,6,7,8,9.10” legitimate track definition table, and “30,31,32,33,34,35,36,37,38,39,40” as tag ID (curbing) in the curbing definition table.

The control unit 310 includes an internal memory that stores therein control programs such as operating system (OS), and computer programs and data for required for various process procedures, and executes various processes. In close relevance to the present invention, the control unit 310 includes a tag data controller 311, the track-legitimacy judging unit 312, an alarm notification controller 313, and a driving-data output unit 314.

The tag data controller 311 receives the tag data (for example, the tag ID and time) from the on-board device 100, and stores the tag data in the tag-history storage unit 321 as well as issues a command to the track-legitimacy judging unit 312 to perform track legitimacy judgment.

The track-legitimacy judging unit 312 compares the tag data stored in the tag-history storage unit 321 and the driving-definition holding unit 322, and judges whether the vehicle is driving on a legitimate track. Specifically, the track-legitimacy judging unit 312 compares the tag data stored in the tag-history storage unit 321 and the driving definitions (legitimate tracks) stored in the driving-definition holding unit 322. If the sequence of the tag data is identical to any of the sequences in the driving definitions (legitimate tracks), the track-legitimacy judging unit 312 judges that the vehicle is driving on a legitimate track. If the sequence of the tag data is identical to the sequence in the driving definition (barred spots), the track-legitimacy judging unit 312 judges that the vehicle is not driving on a legitimate track. The track-legitimacy judging unit 312 stores the track legitimacy result in the tag-history storage unit 321. The track-legitimacy judging unit 312 is referred to as track legitimacy judgment in the claims.

For example, upon receiving the command to perform track legitimacy judgment from the tag data controller 311, the track-legitimacy judging unit 312 judges whether the tag data stored in the tag-history storage unit 321 and the driving definition match to judge whether the vehicle is driving on a legitimate track. In other words, the track-legitimacy judging unit 312 judges whether the tag data held in the tag-history storage unit 321 and the driving definitions corresponding to legitimate tracks (for example, tag retrieval sequence of “Route A” (see FIG. 4A)) match, and if they do, judges that the vehicle is driving on a legitimate track and ends the judgment process. Otherwise, the track-legitimacy judging unit 312 judges that the vehicle is not driving on a legitimate track, stores the track legitimacy result in the tag-history storage unit 321, and notifies the alarm notification controller 313 described later. The track-legitimacy judging unit 312 further judges whether the tag data stored in the tag-history storage unit 321 and the driving definition corresponding to barred spots (the tag IDs stored in the curbing definition table), and if they do, judges that the vehicle has run off the track or has run into the curb. The track-legitimacy judging unit 312 then stores the track legitimacy result in the tag-history storage unit 321 and notifies the alarm notification controller 313. If the tag data stored in the tag-history storage unit 321 and the driving definition corresponding to barred spots do not match, the track-legitimacy judging unit 312 judges that the vehicle has not run off the track nor run into the curb, and ends the process.

For example, if the tag ID (in retrieval sequence) stored in the tag-history storage unit 321 is “1,31,3,4,5,6,7,” (see FIG. 3), the track-legitimacy judging unit 312 judges that the vehicle has run into the curb as the tag data “31” matches the tag ID “31” (see FIG. 4B) stored in the curbing definition table, stores “ran into curb” in the tag-history storage unit 321 as the track legitimacy result, and notifies the alarm notification controller 313 described later.

The alarm notification controller 313 sets off an alarm in the on-board device 100 if the track legitimacy result by the track-legitimacy judging unit 312 matches with an alarm definition. For example, if the track-legitimacy judging unit 312 judges that the vehicle has run into the curb, the alarm notification controller 313 sets off an alarm announcing that the vehicle has run into the curb.

The driving-data output unit 314 retrieves the tag history from the tag-history storage unit 321 and outputs the tag history via the output unit 340 upon receiving a command via the input unit 350 to output the tag data (driving-related data) stored in the tag-history storage unit 321. For example, upon receiving a command to output the tag data (driving-related data) pertaining to “Trainee No. 54” from the input unit 350, the driving-data output unit 314 retrieves the tag history corresponding to the specified trainee stored in the tag-history storage unit 321. In other words, the driving-data output unit 314 retrieves from the tag-history storage unit 321 “2006-11-17” as training date, “A001” as vehicle ID, “16h:00m:20s”, “16h:00m:30s”, “16h:01m:50s”, “16h:10m:55s”, “16h:02m:20s”, “16h:02m:40s”, “16h:02m:55s” as time, and “1,31,3,4,5,6, 7” at tag ID, and “ran into curb” as the track legitimacy result, and outputs the retrieved tag history (for example, by displaying the tag history on a display, or printing it on a sheet).

The management center device 300 part of the driving training assisting device is installed in the office in the description so far. However, the management center device 300 can be an electronic device such as a hand-held terminal (HHT) that can be operated as an on-board driving training assisting device. The driving training assisting device can be connected to another system (for example, a system managing data pertaining to the trainees receiving training), and trainee data managed by the system and driving-related data management by the driving training assisting device can be output together by mutual cooperation. Further, the alarm notification device can be provided as a separate entity independent of the tag-data reading device. For example, the HHT can be used both for alarm setoff and for outputting the driving result. Moreover, the radio IC tags can be placed in such a way as to efficiently use the communication range that is determined by the frequencies of the radio IC tags (for example, by using long-range radio IC tags in the driving definitions that indicate the legitimate tracks and short-range IC tags in the driving definition that indicates situations such as driving into the curb) and set driving definitions efficiently.

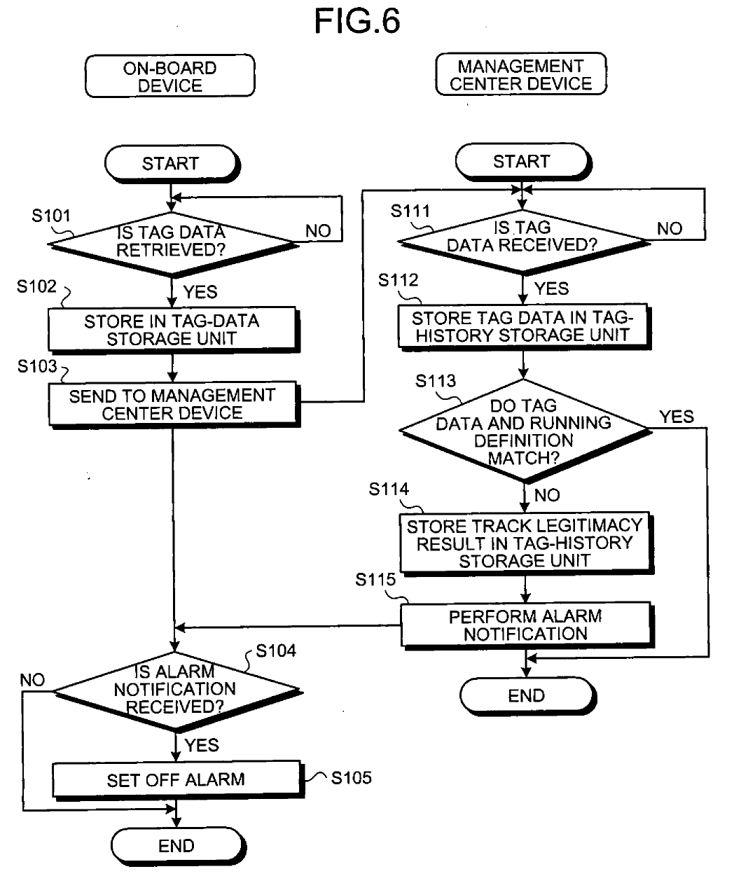

A track-legitimacy judgment process performed by the driving training assisting device is described below. FIG. 6 is a flowchart of the track-legitimacy judgment process according to the first embodiment.

As shown in FIG. 6, in the on-board device 100, the tag-data retrieving unit 110 retrieves the tag data read from the radio IC tags that fall in the path of the vehicle (Yes at step S101), and stores the tag data and the time at which the tag data is retrieved (for example, “16h:00m:20s”) in an associated form in the tag-data storage unit 120 (step S102). The tag-data retrieving unit 110 then sends the tag data and the time stored in the tag-data storage unit 120 to the communication unit (on-board) 130 through the management center device 300 (step S103).

When the tag data sent from the on-board device 100 is received by the management center device 300 (Yes at step S111), the tag data controller 311 stores the tag data in the tag-history storage unit 321 (step S112).

Upon receiving a command to perform the track legitimacy judgment from the tag data controller 311, the track-legitimacy judging unit 312 of the management center device 300 judges whether the tag data stored in the tag-history storage unit 321 and the driving definition (for example, legitimate track) match (step S113).

If the tag data stored in the tag-history storage unit 321 and the driving definition match (Yes at step S113), the track-legitimacy judging unit 312 of the management center device 300 judges that the vehicle is driving on a legitimate track, and ends the process. Otherwise (No at step S113), the track-legitimacy judging unit 312 judges that the vehicle is not driving on a legitimate track, stores the track legitimacy result in the tag-history storage unit 321 (step S114). The alarm notification controller 313 notifies the alarm to the on-board device 100 (step S115).

Upon receiving the alarm notification from the management center device 300 (Yes at step S104), the alarm notification device 400 of the on-board device 100 sets off the alarm and ends the process (step S105). If no alarm notification is received from the management center device 300 (No at step S104), the process is ended without setting off the alarm.

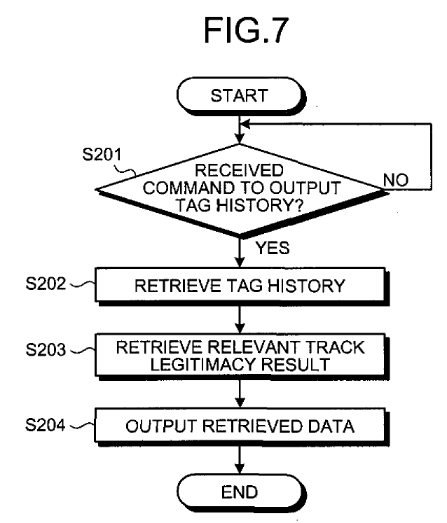

A driving-data output process performed by the driving training assisting device is described below. FIG. 7 is a flowchart of the driving-data output process.

Upon receiving a command to output the tag history (tag data) from the input unit 350 (Yes at step S201), the driving-data output unit 314 retrieves the associated tag history stored in the tag-history storage unit 321 (step S202).

The driving-data output unit 314 retrieves the relevant track legitimacy result (for example, “ran into curb”) (step S203), and outputs the retrieved data (step S204). The driving-data output unit 314 outputs the driving data on the display or as a printout on a sheet.

Thus, according to the first embodiment, the management center device 300 holds driving definitions, and the on-board device 100 retrieves the tag data read from the radio IC tags that fall in the path of the vehicle by the tag-data reading device 200. The management center device 300 compares the tag data and the driving definition to judge whether the vehicle is driving on a legitimate track. Thus, it can be judged whether the vehicle is driving on a legitimate track based on the positional relation of the radio IC tags and the vehicle. Consequently, it can be assessed objectively whether the vehicle is driving on a legitimate track, uninfluenced by the evaluator's own opinion or capability.

Further, according to the first embodiment, the on-board device 100 receives an objective track legitimacy result from the management center device 300 even as the vehicle is driving, making the training very effective.

According to the first embodiment, the management center device 300 holds driving definitions in the form of series of tag data of the radio IC tags placed on legitimate tracks on which the vehicle should be driving, and determines that the vehicle is driving on a legitimate track if, upon comparison, the plurality of tag data read and stored while the vehicle is driving and the driving definition are identical. Consequently, legitimacy of the driving condition can be judged by judging whether the vehicle is driving on a legitimate track.

Further according to the first embodiment, the management center device 300 holds a driving definition in the form of a series of tag data of the radio IC tags placed at barred spots where the vehicle should not be driving, and judges that the driving condition of the vehicle is not legitimate if, upon comparison, the tag data read and stored while the vehicle is driving and the driving definition are identical. Consequently, legitimacy of the driving condition can be judged by judging whether the vehicle is driving on a legitimate track.

In the first embodiment, the driving training assisting device only judges whether the vehicle is driving on a legitimate track and sets off an alarm if the vehicle deviates from the legitimate track. However, the driving training assisting device can also determine a legitimacy level (for example, “1”, “2”, “3”, etc.) of the track on which the vehicle is driving and sets off alarm according to the legitimacy level (for example, “Prompting” in case of “1”, “Warning in case of “3”).

The driving training assisting device according to a second embodiment of the present invention determines the legitimacy level of the track on which the vehicle is driving and sets off alarm according to the legitimacy level. The features in the driving training assisting device according to the second embodiment that are similar to those of the driving training assisting device according to the first embodiment will be touched upon only briefly.

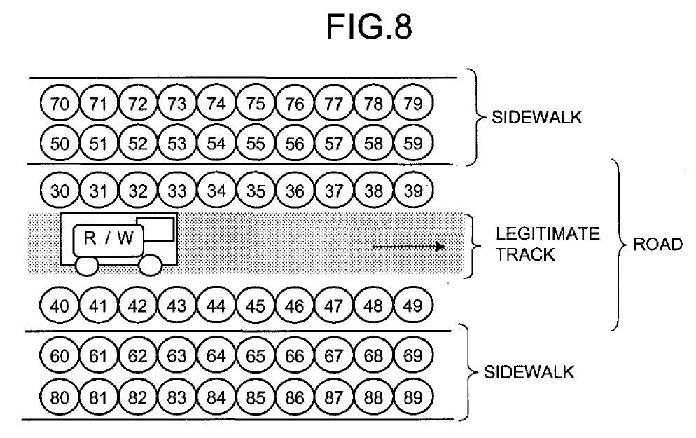

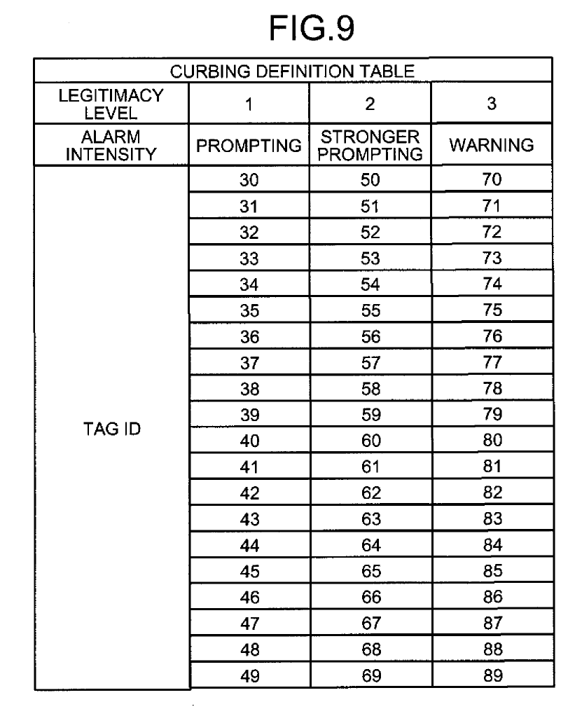

The driving training assisting device according to the second embodiment is explained with reference to FIGS. 8 and 9. FIG. 8 is a schematic for explaining an overview and salient feature of the driving training assisting device according to the second embodiment. FIG. 9 is a drawing of storage contents of a driving-definition holding unit according to the second embodiment.

As shown in FIGS. 8 and 9, a management center device according to the second embodiment holds driving definitions in the form of legitimacy level, an alarm intensity, and the tag data, which are in an associated form. For example, as shown in FIGS. 8 and 9, the legitimacy level of the zone that is slightly off the legitimate track on the road is set as “1”, the portion of the sidewalk that is proximal to the road as “2”, and the portion of the sidewalk that is distal to the road as “3”, and the corresponding tag data are associated with the respective levels. For example, the legitimacy level “1” and the tag ID “30 to 49” are stored in an associated form.

The management center device according to the second embodiment also holds the legitimacy level and the alarm intensity in an associated form. For example, as shown in FIGS. 8 and 9, the management center device according to the second embodiment holds “Legitimacy level 1” associated with “Prompting”, “Legitimacy level 2” associated with “Stronger prompting”, and “Legitimacy level 3” associated with “Warning”.

The driving training assisting device according to the second embodiment then compares the tag data stored in a predetermined storage unit (for example, the tag-history storage unit 321 or the driving-definition holding unit 322 shown in FIG. 2), and judges the legitimacy level of the track on which the vehicle is driving. In the examples shown in FIGS. 8 and 9, if the tag ID retrieved is “33”, the driving training assisting device determines the legitimacy level to be “1”. Similarly, if the tag ID is “54”, the legitimacy level is determined to be “2”. Likewise, if the tag ID is “75”, the legitimacy level is determined to be “3”.

The management center device according to the second embodiment then notifies the track legitimacy result in different alarm modes according to the legitimacy level of the track on which the vehicle is driving. In the example shown in FIG. 9, the management center device according to the second embodiment sets the alarm mode as “Prompting” if the “Legitimacy level” of the vehicle is “1”. An on-board device according to the second embodiment sets off an alarm that corresponds to the alarm mode “Prompting”. The track legitimacy judging process is principally performed by the track-legitimacy judging unit 312 shown in FIG. 2.

Thus, according to the second embodiment, the management center device holds driving definitions in which the legitimacy levels in an associated form with their respective tag data and alarm intensities, and determines the legitimacy level (for example, “1”, “2”, or “3”) of the track on which the vehicle is driving by comparing the tag data read and stored while the vehicle is driving with the driving definition. As a result, legitimacy of the track on which the vehicle is driving can be determined more precisely.

According to the second embodiment, the management center device notifies the track legitimacy result to the vehicle in different alarm modes according to the legitimacy level (for example, by selecting one of “Prompting”, “Stronger prompting”, and “Warning”, depending on the legitimacy level). Consequently, the notification that is more suited to the track legitimacy result of the legitimacy of the track on which the vehicle is driving can be issued.

In the first and second embodiments, the driving training assisting device judges whether the vehicle is driving on a legitimate track or is in a legitimate spot. The driving training assisting device can also be configured to judge whether the vehicle is driving at a legitimate speed.

In a third embodiment of the present invention, the driving training assisting device judges whether the vehicle is driving at a legitimate speed. The features in the driving training assisting device according to the third embodiment that are similar to those of the driving training assisting devices according to the first and second embodiments will be touched upon only briefly.

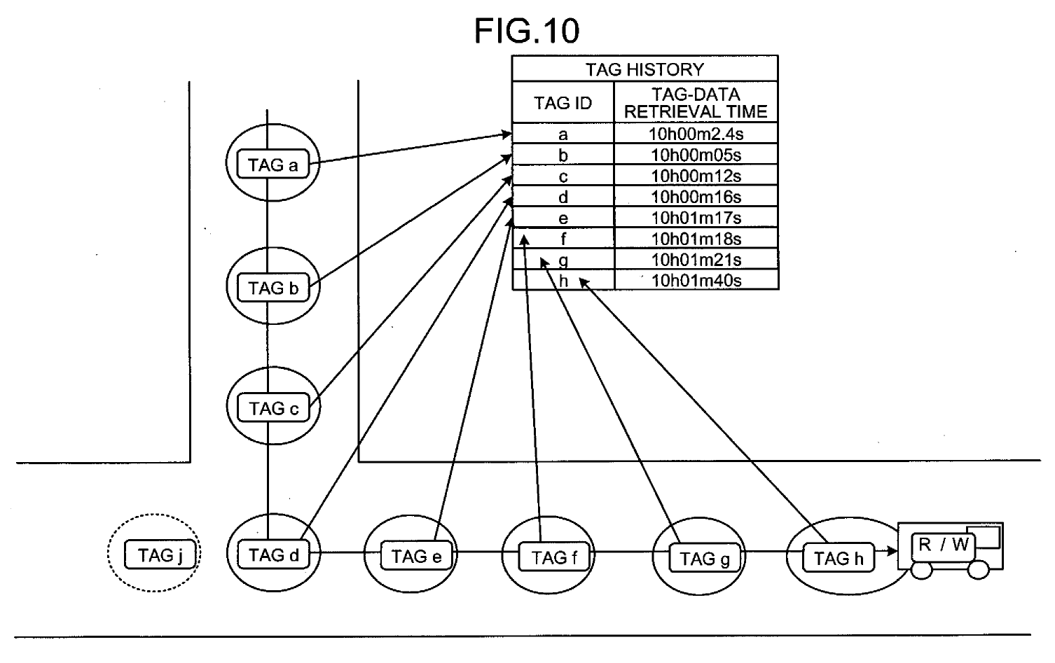

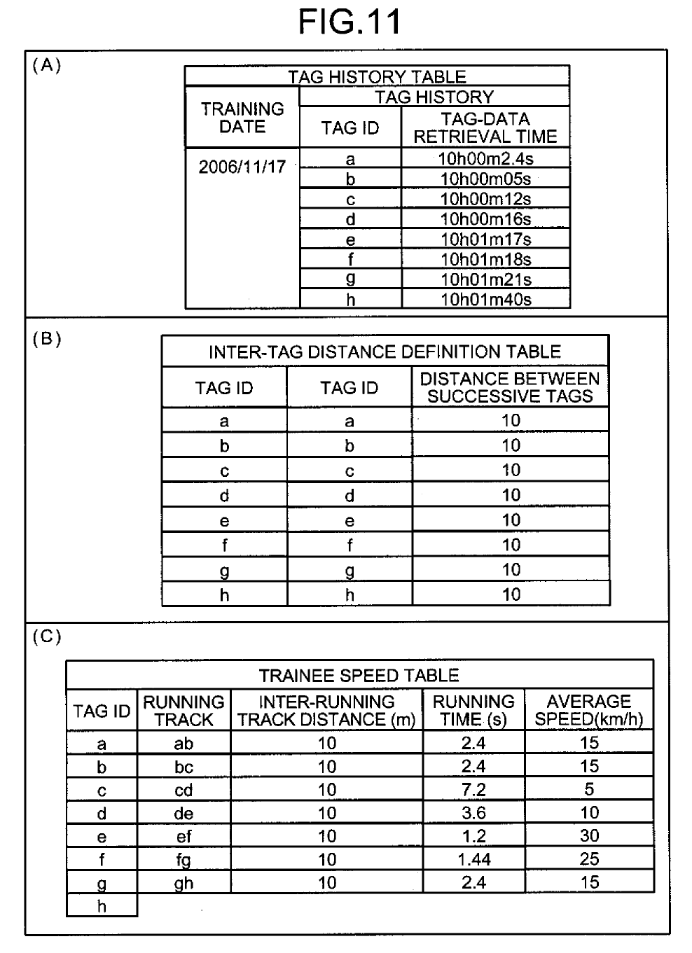

FIG. 10 and FIGS. 11A to 11C are schematics for explaining the driving training assisting device according to the third embodiment. FIG. 10 is a schematic for explaining an overview and salient feature of the driving training assisting device according to the third embodiment. FIGS. 11A to 11C are schematics for explaining a legitimate-speed judgment process according to the third embodiment.

As shown in FIG. 10 and FIGS. 11A to 11C, a management center device according to the third embodiment determines the speed at which the vehicle is driving based on a plurality of tag data stored in a predetermined storage unit (for example, the tag-history storage unit 321 shown in FIG. 2), and judges the legitimacy of the speed. Specifically, as shown in FIG. 11A, the management center device stores the columns training date, tag ID, and tag-data retrieval time in an associated form in a tag history table. The management center device further holds, as shown in FIG. 11B, an inter-tag distance definition table containing two tag ID columns, and a column for distance between successive tags, indicating the distance between two consecutive radio IC tags. Further, as shown in FIG. 11C, the management center device creates a trainee speed table which contains the columns driving track indicating the track on which the vehicle has been driving, inter-driving track distance indicating the distance of the driving track, driving time indicating the time in which the vehicle covered the driving track, and average speed indicating the average speed of the vehicle, calculated based on the tag history table and the inter-tag distance definition table.

For example, if the management center device according to the third embodiment stores the following tag ID and time in an associated form in the tag history table, namely, “a, 10h:00m:2.4s” and “b, 10h:00m:5s”, the following tag IDs and the inter-tag distance in an associated form in the inter-tag distance definition table, namely, “a, b, 10”, then it determines the driving track as “ab”, the inter-driving track distance as “10”, the driving time as 2.4 s, and calculates the average speed as “15 km/h”.

Thus, according to the third embodiment, the management center device calculates the speed at which the vehicle is driving based on the plurality of tag data stored in the storage unit and judges the legitimacy of the driving condition of the vehicle based on the speed. Consequently, legitimacy of the driving condition of the vehicle can be succinctly judged.

The embodiments described above allow various modifications. The modifications to the described embodiments are collectively described below as a fourth embodiment of the present invention.

The present invention can also be applied for judging legitimacy concerning distance between two vehicles.

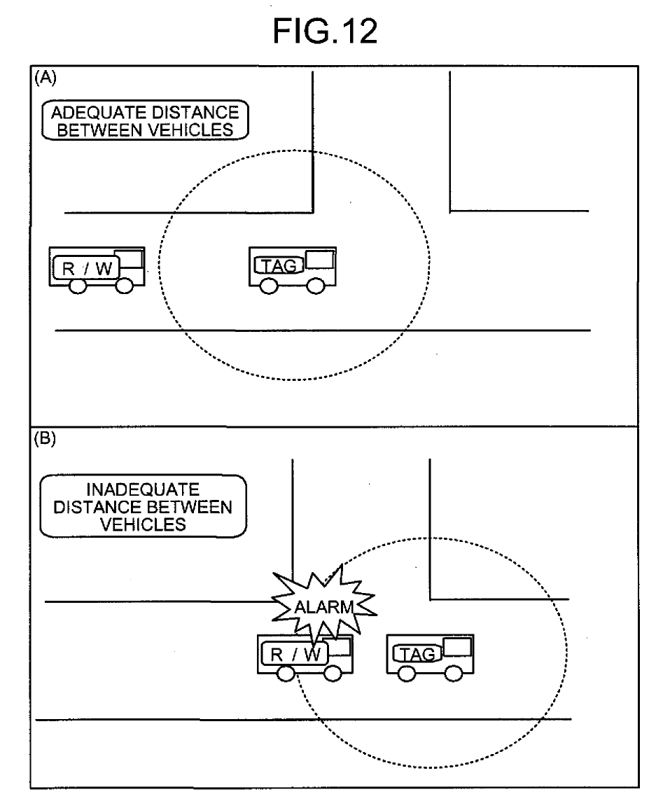

Specifically, radio IC tags are installed on the vehicles, and the on-board device of one vehicle retrieves the tag data read from the radio IC tag of another vehicle. The management center device judges the legitimacy of the driving condition of the vehicle based on whether tag data could be read from the other vehicle. For example, if the distance between the two vehicles is sufficiently large enough to be unable to read the tag data of the other vehicle (see FIG. 12A), the management center device judges that the vehicle is maintaining a safe distance with respect to the other vehicle. However, if the distance between the two vehicles reducing, enabling the tag data of the other vehicle to be read (see FIG. 12B), the management center device judges the vehicle is not maintaining a safe distance with respect to the other vehicle. FIGS. 12A and 12B are schematics for explaining an overview and salient feature of the driving training assisting device that judges the legitimacy of the driving condition based on the distance between vehicles.

Thus, the driving training assisting device retrieves the tag data read from the radio IC tag installed on another vehicle, and judges the legitimacy of the driving condition of the vehicle based on whether the tag data could be retrieved from the other vehicle. Consequently, the legitimacy of the driving condition can be succinctly judged by judging whether the distance between two vehicles is legitimate.

In the embodiments described above, only one tag data is read from one spot. However, the driving training assisting device can be configured so that a plurality of tag data can be simultaneously read from one spot.

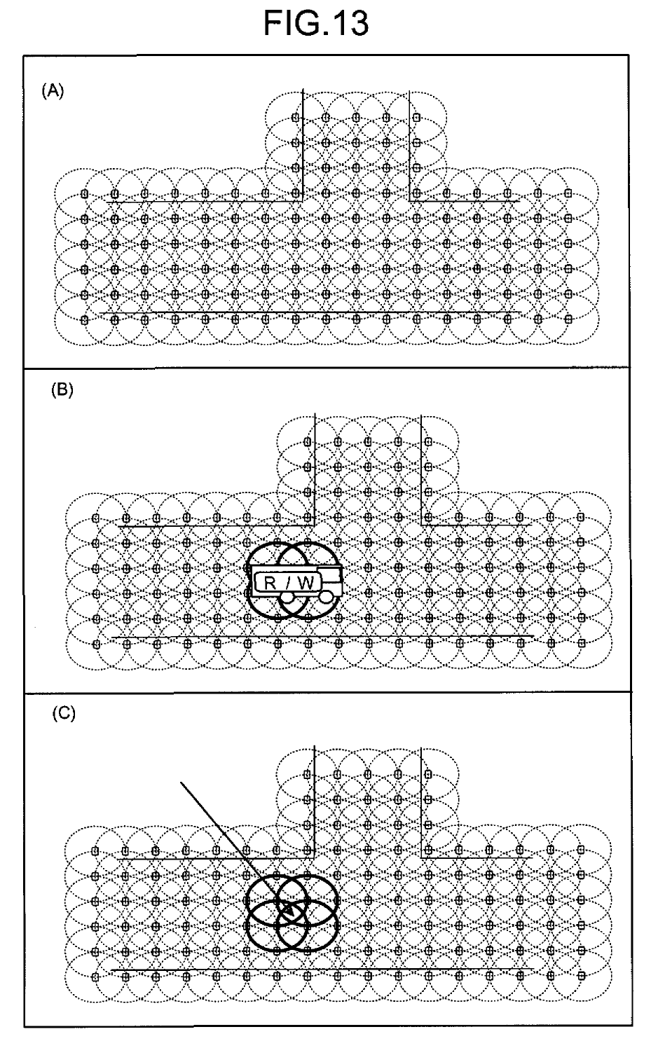

Specifically, the management center device holds a driving definition in which a plurality tag data indicates one driving condition and compares the tag data that are simultaneously retrieved and stored in a predetermined storage unit (for example, the tag-history storage unit 321 or the driving-definition holding unit 322 shown in FIG. 2) and the driving definition to judge the legitimacy of the driving condition of the vehicle. For example, the location of the vehicle can be precisely identified (see FIG. 13C) based on the tag data of the radio IC tags that are simultaneously retrieved (see FIG. 13B) on a driving zone that has radio IC tags set very close together so that at any point, the vehicle will pick up tag data from a plurality of radio IC tags (see FIG. 13A). FIGS. 13A to 13C are schematics for explaining an overview and salient feature of the driving training assisting device that sets the driving definition based on a plurality of tag data.

Thus, the driving training assisting device holds the driving definition in which a plurality of tag data indicates one driving condition, and judges the legitimacy of the driving condition of the vehicle by comparing the plurality of tag data simultaneously retrieved and stored with the driving definition. Consequently, a broader judgment of legitimacy of driving condition can be performed as different types of driving definitions can be used (based, for example, on the sequence in which the plurality of radio IC tags are read).

In the embodiments described above, to draw attention and to warn the learner, a buzzer is used as an alarm. The alarm notification can also be in the form of a warning being displayed on a display unit, or a blinking lamp.

The process procedures, the control procedures, specific names, and data, including various parameters mentioned (for example, in FIGS. 3, 4, 5, 9, 10, 11, etc.) in the description and drawings can be changed as required unless otherwise specified.

The constituent elements of the device illustrated are merely conceptual and may not necessarily physically resemble the structures shown in the drawings. For instance, the device need not necessarily have the structure that is illustrated (for example, in FIG. 2, the on-board device 100 and the management center device 300 can be integrated into a single on-board unit that can realize the invention). The device as a whole or in parts can be broken down or integrated either functionally or physically in accordance with the load or how the device is to be used. The process functions performed by the device can be entirely or partially realized by the CPU or a computer program executed by the CPU or by a hardware using wired logic.

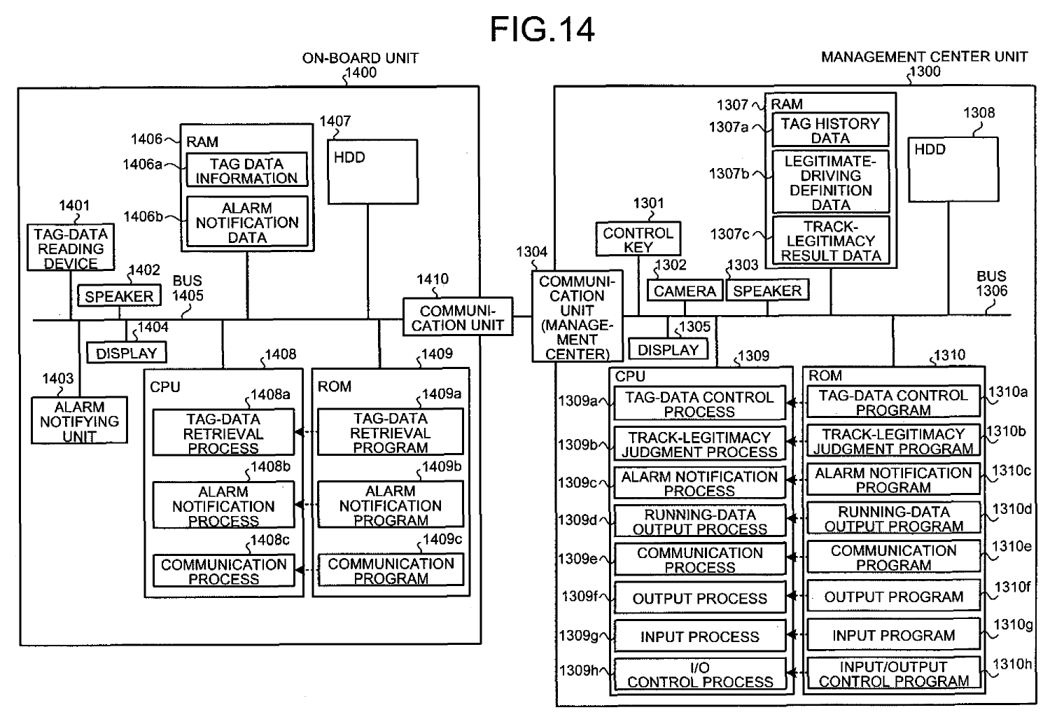

The driving training assisting device is explained above as hardware. However, it can be implemented as software. In other words, a computer program can be executed on a personal computer or a workstation to realize the same functions as the driving training assisting device. FIG. 14 is a schematic drawing of the computer programs that cause a computer to function as a driving training assisting device.

As shown in FIG. 14, an on-board unit 1400 includes a tag-data reading device 1401, a speaker 1402, an alarm notifying unit 1403, a display 1404, a random access memory (RAM) 1406), a hard disk drive (HDD) 1407, a central processing unit (CPU) 1408, a read-only memory (ROM) 1409, a communication unit (on-board) 1410, and a bus 1405 that interconnects all the devices mentioned above. A management center unit 1300 includes a control key 1301, a camera 1302, a speaker 1303, a communication unit (management center) 1304, a display 1305, a RAM 1307, an HDD 1308, a CPU 1309, a ROM 1310, and a bus 1306 that interconnects all the devices mentioned above. The on-board unit 1400 and the management center unit 1300 are connected to each other over a network or via a cable or wirelessly (for example, through infra-red communication, Bluetooth (registered trademark), etc.) through the communication unit (on-board) 1410 and the communication unit (management center) 1304.

As shown in FIG. 14, the ROM 1409 holds therein a tag-data retrieval program 1409a, an alarm notification program 1409b, and a communication program 1409c, which correspond respectively to the tag-data retrieving unit 110, the alarm notifying unit 140, and the communication unit (on-board) 130 of the first embodiment. Similar to the on-board device 100 shown in FIG. 2, whose constituent components can be integrated as required, the computer programs 1409a to 1409c can be integrated as required.

The CPU 1408 reads the computer programs 1409a to 1409c from the ROM 1409, and executes a tag-data retrieval process 1408a, an alarm notification process 1408b, and a communication process 108c, respectively, which correspond to the tag-data retrieving unit 110, the alarm notifying unit 140, and the communication unit (on-board) 130, respectively, shown in FIG. 2.

The ROM 1310 holds therein a tag-data control program 1310a, a track-legitimacy judgment program 1310b, an alarm notification program 1310c, a driving-data output program 1310d, a communication program 1310e, an output program 1310f, an input program 1310g, and an input/output (I/O) control program 1310h. Similar to the management center device 300 shown in FIG. 2, whose constituent components can be integrated as required, the computer programs 1310a to 1310h can be integrated as required.

The CPU 1309 reads the computer programs 1310a to 1310h from the ROM 1310 and executes a tag-data control process 1309a, a track-legitimacy judgment process 1309b, an alarm notification process 1309c, a driving-data output process 1309d, a communication process 1309e, an output process 1309f, an input process 1309g, and an I/O control process 1309h, respectively, which correspond to the tag data controller 311, the track-legitimacy judging unit 312, the alarm notification controller 313, the driving-data output unit 314, the communication unit (management center) 330, the output unit 340, the input unit 350, and the I/O control unit 360, respectively, shown in FIG. 2.

The computer programs 1409a to 1409c and the computer programs 1310a to 1310h of the present embodiment can also be stored in a portable physical medium that can be inserted into the on-board device 100 or the management center device 300, such as a flexible disk, a compact disk-read-only memory (CD-ROM), a magneto optic (MO) disk, a digital versatile disk (DVD), an integrated circuit (IC) card, etc. Alternatively, they can be stored in a fixed physical medium that can be connected externally to the on-board device 100 or the management center device 300, such as an HDD or on another computer (or server) connected to the on-board device 100 and the management center device 300 over a public line, Internet, local area network (LAN), wide area network (WAN), etc. The on-board device 100 and the management center device 300 can read the computer programs from these mediums and execute the various processes.

As described above, according to one aspect of the present invention, the driving training assisting device judges the legitimacy of the driving condition of the vehicle based on the positional relation between the radio IC tags and the vehicle. As a result, the legitimacy of the driving condition of the vehicle can be assessed objectively, uninfluenced by the evaluator's own opinion or capability.

Furthermore, according to another aspect of the present invention, the driving training assisting device receives an objective track legitimacy result related to the legitimacy of the driving condition of the vehicle even as the vehicle is driving. Consequently, effective training can be imparted.

Moreover, according to still another aspect of the present invention, the driving training assisting device determines the legitimacy level (for example, “1”, “2”, or “3”) of the driving condition of the vehicle, enabling a more precise judgment of the legitimacy of the driving condition of the vehicle.

Furthermore, according to still another aspect of the present invention, the driving training assisting device changes the alarm mode according to the legitimacy level of the driving condition of the vehicle (for example, by selecting among “Prompting”, “Stronger prompting”, and “Warning” as the alarm mode, according to the driving condition of the vehicle). Consequently, an alarm notification that is more suited to the track legitimacy result can be issued.

Moreover, according to still another aspect of the present invention, the driving training assisting device uses various types of driving definitions can be used (based, for example, on the sequence in which the plurality of radio IC tags are read). Consequently, a broader judgment of legitimacy of driving condition can be performed as different types of driving definitions can be used (based, for example, on the sequence in which the plurality of radio IC tags are read).

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for assisting a training of driving a vehicle, the computer program causing a computer to execute:
first storing including storing a driving definition that is defined using tag data of a plurality of radio integrated-circuit tags installed in a driving area of the vehicle, the driving definition indicating at least one of an adequate driving condition and an inadequate driving condition for the vehicle;
acquiring tag data read by a radio integrated-circuit tag reading device provided in the vehicle from the radio integrated-circuit tags with a driving of the vehicle;
second storing including storing the tag data acquired at the acquiring in a predetermined storage unit; and
judging an adequacy of a driving condition of the vehicle by comparing the tag data stored at the second storing with the driving definition stored at the first storing.

2. The computer-readable recording medium according to claim 1, wherein the computer program further causes the computer to execute notifying a result of judgment on the adequacy of the driving condition to the vehicle.

3. The computer-readable recording medium according to claim 2, wherein
the first storing includes storing a driving definition that is associated with an adequacy level of the driving condition indicating a level of an adequacy or an inadequacy of the driving condition for the vehicle, and
the judging includes judging an adequate level of the driving condition for the vehicle by comparing the tag data stored at the second storing with the driving definition stored at the first storing.

4. The computer-readable recording medium according to claim 3, wherein the notifying includes notifying the result of judgment to the vehicle in different manners depending on adequacy levels of the driving condition judged at the judging.

5. The computer-readable recording medium according to claim 1, wherein
the first storing includes storing a driving definition in which a plurality of pieces of tag data indicates a single driving condition,
the acquiring includes acquiring the pieces of tag data simultaneously,
the second storing includes storing the pieces of tag data simultaneously acquired at the acquiring in the predetermined storage unit, and
the judging includes judging the adequacy of the driving condition by comparing the pieces of tag data stored at the second storing with the driving definition stored at the first storing.

6. The computer-readable recording medium according to claim 5, wherein
the first storing includes storing a driving definition in which series of tag data of radio integrated-circuit tags installed along an adequate driving route for the vehicle, and
the judging includes
comparing the pieces of tag data stored at the second storing with the driving definition stored at the first storing, and
judging, when the pieces of tag data stored at the second storing is in a same sequence as series of tag data in the driving definition, that the driving condition of the vehicle is adequate.

7. The computer-readable recording medium according to claim 5, wherein
the first storing includes storing a driving definition in which series of tag data of radio integrated-circuit tags installed along an inadequate driving route for the vehicle, and
the judging includes
comparing the pieces of tag data stored at the second storing with the driving definition stored at the first storing, and
judging, when the pieces of tag data stored at the second storing is in a same sequence as series of tag data in the driving definition, that the driving condition of the vehicle is inadequate.

8. The computer-readable recording medium according to claim 5, wherein the judging includes
calculating a driving speed of the vehicle from the pieces of tag data stored at the second storing, and
judging the adequacy of the driving condition from the driving speed calculated at the calculating.

9. The computer-readable recording medium according to claim 1, wherein
the acquiring includes acquiring tag data read by a radio integrated-circuit tag provided on other vehicle, and
the judging includes judging the adequacy of the driving condition based on whether the tag data is read by the radio integrated-circuit tag provided on the other vehicle.

10. A method of assisting a training of driving a vehicle, comprising:
first storing including storing a driving definition that is defined using tag data of a plurality of radio integrated-circuit tags installed in a driving area of the vehicle, the driving definition indicating at least one of an adequate driving condition and an inadequate driving condition for the vehicle;
acquiring tag data read by a radio integrated-circuit tag reading device provided in the vehicle from the radio integrated-circuit tags with a driving of the vehicle; second storing including storing the tag data acquired at the acquiring in a predetermined storage unit; and
judging an adequacy of a driving condition of the vehicle by comparing the tag data stored at the second storing with the driving definition stored at the first storing.

11. An apparatus for assisting a training of driving a vehicle, comprising:
a first storing unit that stores therein a driving definition that is defined using tag data of a plurality of radio integrated-circuit tags installed in a driving area of the vehicle, the driving definition indicating at least one of an adequate driving condition and an inadequate driving condition for the vehicle;
an acquiring unit that acquires tag data read by a radio integrated-circuit tag reading device provided in the vehicle from the radio integrated-circuit tags with a driving of the vehicle;
a second storing unit that stores the tag data acquired by the acquiring unit in a predetermined storage unit; and
a judging unit that judges an adequacy of a driving condition of the vehicle by comparing the tag data stored in the second storing unit with the driving definition stored in the predetermined storage unit.
